(19) United States
(12) Patent Application Publication
(10) Pub. No.: US 2021/0018672 A1
(43) Pub. Date: Jan. 21, 2021

(54) LIGHT RECEIVER, LIGHT PROJECTOR, AND PHOTOELECTRIC SENSOR

(71) Applicant: Panasonic Intellectual Property Management Co., Ltd., Osaka (JP)

(72) Inventor: TAKASHI MATSUDA, Hyogo (JP)

(21) Appl. No.: 16/912,784

(22) Filed: Jun. 26, 2020

(30) Foreign Application Priority Data
Jul. 16, 2019 (JP) 2019-131375

(51) Int. Cl. F21V 8/00; G02B 5/04; G01D 5/353

(52) U.S. Cl. CPC G02B 6/0006; G01D 5/35338; G02B 6/0008; G02B 5/045

(57) ABSTRACT

Light receiver includes first optical element emitting received light to a light receiving fiber side; and second optical element collecting the light incident from the first optical element on a light receiving fiber. First optical element includes prism surface inclined with respect to light incident surface. The prism surface includes first surface 4a reflecting the incident light parallel to the light incident surface and second surface reflecting the light on a side opposite to the second optical element. The first surface includes first region in which the light reflected in parallel to the light incident surface is incident on the second optical element, and second region in which the light reflected in parallel to the light incident surface transmits through the adjacent second surface, is incident and refracts on the adjacent first surface, and is incident on the second optical element while being totally reflected inside the first optical element.

### BACKGROUND

### 1. Technical Field

The present disclosure relates to a light receiver and a light projector constituting a photoelectric sensor, and a photoelectric sensor including these.

### 2. Description of the Related Art

A photoelectric sensor of the related art is, for example, constituted of a light projector that guides light of an LED or the like to an optical fiber and irradiates, with light, a desired detection region such as a lens or an optical element, a light receiver that is disposed in front of the detection region, receives the light from the light projector, and collects the light on the optical fiber, and a detector that detects an amount of light from the optical fiber. The photoelectric sensor having such a configuration can detect the presence or absence of an object, a shape thereof, and the like because the amount of light on a light receiving side decreases when the object passes through the detection region.

In order to widen the detection region, a photoelectric sensor is known in which an optical element having a plurality of reflection prisms widens light and irradiates the light, and the light is narrowed and received on a light receiving side through the reflection prisms (for example, Japanese Patent No. 6061725).

### SUMMARY

A light receiver according to the present disclosure is a light receiver for receiving light projected from a light projector and collecting the received light on a light receiving fiber, the light receiver including: a first optical element emitting the light projected from the light projector toward the light receiving fiber; and a second optical element collecting the light emitted from the first optical element on the light receiving fiber. The first optical element includes a light incident surface on which the light projected from the light projector is incident, and a prism surface on which a plurality of prism portions each having a triangular cross section are periodically formed in a direction inclined with respect to the light incident surface. Each of the prism portions includes a first surface that reflects the light incident from the light incident surface toward the second optical element to be parallel to the light incident surface, and a second surface that reflects the light incident from the light incident surface in a direction opposite to the second optical element. The first surface of each of the prism portions includes a first region and a second region, the first region causing the light to be directly incident on the second optical element, the second region causing the light to transmit through the second surface of the prism portion, to be incident and to refract on the first surface of another prism portion adjacent to the prism portion, and to be incident on the second optical element while being totally reflected inside the first optical element. The second optical element collects, on the light receiving fiber, the light incident from first region and the light obtained by totally reflecting light incident from the second region by a side wall of the second optical element.

### BRIEF DESCRIPTION OF THE DRAWINGS

FIG. 1 is a sectional view schematically illustrating a configuration of a light receiver according to an embodiment of the present disclosure;

FIG. 2 is an enlarged sectional view illustrating a portion of a prism surface of a first optical element illustrated in FIG. 1;

FIG. 3 is a sectional view schematically illustrating a configuration of a light projector according to another embodiment of the present disclosure;

FIG. 4 is a sectional view illustrating an optical element of a light receiver having a reflection prism; and

FIG. 5 is an enlarged sectional view of a portion of a prism surface in the optical element of FIG. 4.

### DETAILED DESCRIPTIONS

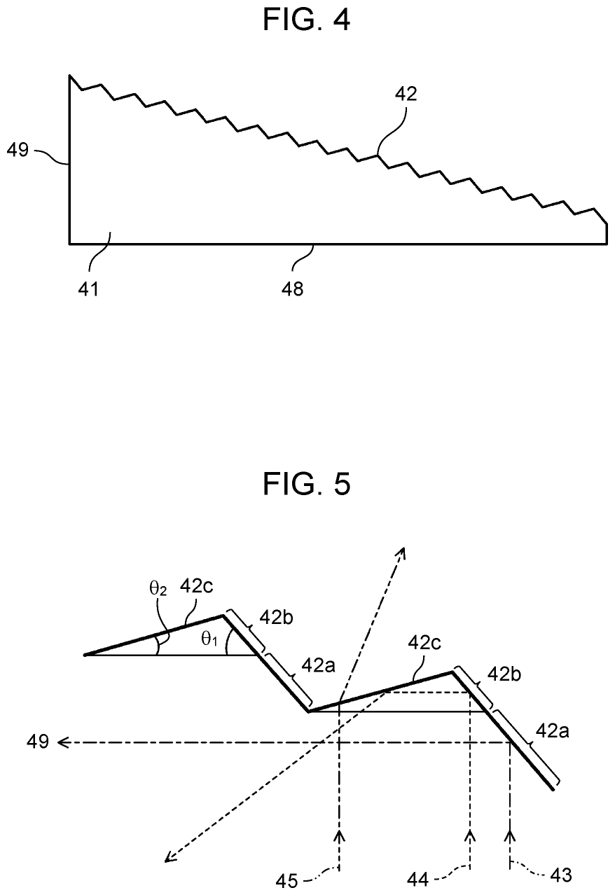

FIG. 4 is a sectional view of a light receiver of the related art including optical element 41 having a reflection prism. As illustrated in FIG. 4, light incident surface 48 of optical element 41 is configured of a flat surface, and in prism surface 42, a surface having a triangular cross section is periodically formed. The light incident on light incident surface 48 is reflected by prism surface 42 and is emitted from light emitting surface 49 to a light receiving fiber (not illustrated).

FIG. 5 is an enlarged sectional view of prism surface 42, and here, a triangular surface is illustrated only for two cycles. Prism surface 42 includes prism surfaces 42a and 42b by which incident light 43 and 44 are reflected, parallel to light incident surface 48, toward a light receiving fiber side (left side in the drawing), and prism surface 42c by which the light is reflected to a side opposite to the light receiving fiber. Prism surfaces 42a and 42b are formed on the same plane.

Prism surface 42a is a region in which the reflected light of incident light 43 is directly incident on the light receiving fiber without hitting prism surface 42c, and prism surface 42b is a region in which the reflected light of incident light 44 is reflected by prism surface 42c and is not incident on the light receiving fiber. Prism surface 42c is a region through which incident light 45 directly transmits and is not incident on the light receiving fiber. Therefore, among the light incident on light incident surface 48, only light 43 reflected by prism surface 42a is incident on the light receiving fiber, and thereby a light receiving efficiency of the light receiving fiber deteriorates. When θ1 is an angle formed by prism surfaces 42a and 42b, and light incident surface 48, and θ2 is an angle formed by prism surface 42c and light incident surface 48, such a state occurs when θ2≤θ1.

The present disclosure is made in view of the points described above, and a main object of the present disclosure is to provide a light receiver in which a light receiving efficiency of a light receiving fiber is improved, and a light projector in which a light incident efficiency on the light receiver is improved.

Hereinafter, embodiments of the present disclosure will be described in detail with reference to the drawings. The present disclosure is not limited to the embodiments described below. Appropriate changes can be made without departing from the scope in which effects of the present disclosure are achieved.

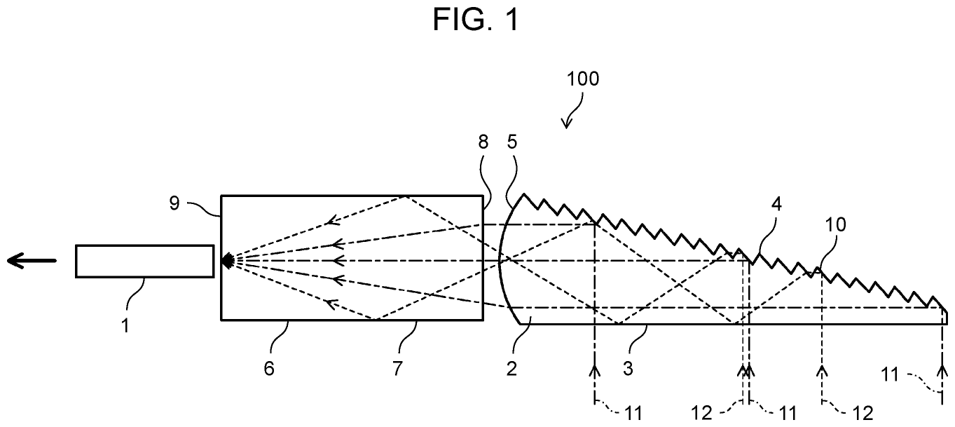

FIG. 1 is a sectional view schematically illustrating a configuration of the light receiver according to an embodiment of the present disclosure. The light receiver in the present embodiment receives light projected from the light projector and collects the received light on the light receiving fiber. The light receiver in the present embodiment can form a photoelectric sensor by being disposed in pair with the light projector.

As illustrated in FIG. 1, light receiver 100 according to the present embodiment includes first optical element 2 that emits received light toward light receiving fiber 1, and second optical element 6 that is disposed between first optical element 2 and light receiving fiber 1, and collects the light incident from first optical element 2 on light receiving fiber 1. First optical element 2 and second optical element 6 are made of, for example, a translucent material such as acrylic or glass.

First optical element 2 includes light incident surface 3 on which light irradiated from the light projector (not illustrated) is incident, prism surface 4 in which a plurality of prism portions 10 each having a triangular cross section are periodically formed in an inclination direction inclined with respect to light incident surface 3, and light emitting surface 5 that emits the light reflected by prism surface 4 toward second optical element 6. Light emitting surface 5 is, for example, a cylindrical lens having a convex lens in a vertical direction in the drawing.

Second optical element 6 is formed of a substantially rectangular parallelepiped, and light incident surface 8 facing light emitting surface 5 of first optical element 2 is a cylindrical lens having a convex lens in a depth direction in the drawing.

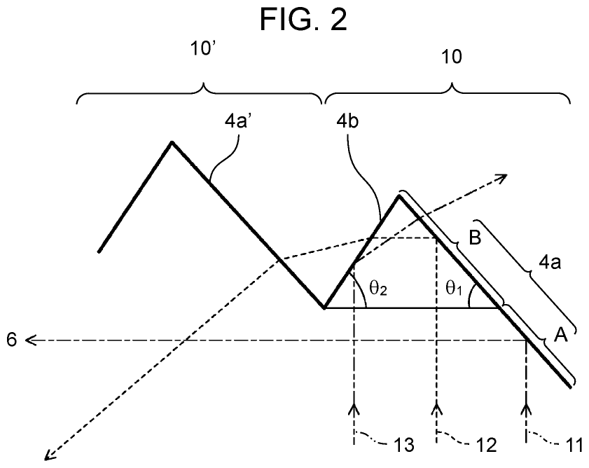

FIG. 2 is an enlarged sectional view illustrating prism portion 10 of prism surface 4 in first optical element 2 illustrated in FIG. 1. Triangular prism portion 10 is illustrated only for two cycles.

As illustrated in FIG. 2, prism portion 10 includes first surface 4a that reflects, parallel to light incident surface 3, light 11 and 12 incident on light incident surface 3 toward second optical element 6, and second surface 4b that reflects light 13 incident on light incident surface 3 in a direction opposite to second optical element 6. First surface 4a includes first region A in which the light reflected parallel to light incident surface 3 is directly incident on second optical element 6, and second region B in which the light reflected parallel to light incident surface 3 transmits through adjacent second surface 4b, is incident and refracts on first surface 4a′ of adjacent prism portion 10′, and as illustrated in FIG. 1, is incident on second optical element 6 while being totally reflected inside first optical element 2. That is, the light incident on light incident surface 3 is divided into three optical paths by first region A and second region B of first surface 4a, and second surface 4b.

As illustrated in FIG. 2, when an angle formed by first surface 4a and light incident surface 3 is θ1, and an angle formed by second surface 4b and light incident surface 3 is θ2, the division of the optical path is realized when θ1 is an angle at which light ray 12 is totally reflected by first surface 4a, and θ2 is an angle at which light ray 12 reflected by first surface 4a is not totally reflected (partially transmits through) by second surface 4b. In the present embodiment, θ1 is set to 45°.

According to the present embodiment, in the light reflected by first surface 4a, not only the light reflected by first region A but also the light reflected by second region B can be incident on second optical element 6. Therefore, second optical element 6 collects, in light receiving fiber 1, the light incident from first region A and light obtained by totally reflecting the light incident from second region B on side wall 7 of second optical element 6. Therefore, the light receiving efficiency of light receiving fiber 1 can be improved.

In a case where angle θ2 formed by second surface 4b and light incident surface 3 is larger than angle θ1 formed by first surface 4a and light incident surface 3, a ratio of the light reflected by second surface 4b to the light incident on light incident surface 3 can be reduced. Thereby, the reflected light by second surface 4b, which is not incident on second optical element 6, can be reduced. As a result, the light receiving efficiency of light receiving fiber 1 can be further improved. Usually, the larger θ2 is, the more remarkable the effect described above becomes, but an upper limit thereof is set to θ2≤90°.

That is, in a case where angle θ2 is larger than angle θ1, in prism surface 4, an area of second surface 4b can be made smaller than an area of first surface 4a. Therefore, the ratio of the light reflected by second surface 4b to the light incident on light incident surface 3 can be made smaller than that of the light reflected by first surface 4a.

Angles θ1 and θ2 are geometrically determined according to a size of first optical element 2 and a size of second optical element 6, and can be derived by drawing or light ray tracing simulation.

In the reflected light divided into three optical paths by prism surface 4, when an intensity of the light reflected by first region A is a, an intensity of the light reflected by second region B is ß, and an intensity of the light reflected by second prism surface 4b is γ, it is preferable to adjust two angles θ1 and θ2 so as to satisfy a relationship of α≥ß≥γ. Thereby, the light receiving efficiency of light receiving fiber 1 can be further improved.

In other words, in prism surface 4, when a projected area on light incident surface 3 corresponding to first region A is Sa, an projected area on light incident surface 3 corresponding to second region B is Sß, and a projected area on light incident surface 3 corresponding to second surface 4b is Sγ, it is preferable to adjust two angles θ1 and θ2 so as to satisfy a relationship of Sα≥Sß≥Sγ.

In a spread (spot diameter) of the light emitted from second optical element 6 and incident on an end surface of light receiving fiber 1, when a spread of the light incident from first region A is W1 and a spread of the light incident from second region B is W2, it is preferable to satisfy a relationship of W2≥W1. Therefore, it is possible to increase a positional deviation margin degree between second optical element 6 and light receiving fiber 1. For example, in a case where deviation on manufacturing occurs in light receiving fiber 1, if spread W2 is small, the light is not incident on light receiving fiber 1. However, if W2 is large, the light is incident on light receiving fiber 1 even if there is a slight deviation, and thereby the margin degree increases.

Light receiver 100 according to the present embodiment receives the light projected from the light projector, and collects the received light on light receiving fiber 1, and is disposed in pair with the light projector, thereby capable of constituting a photoelectric sensor.

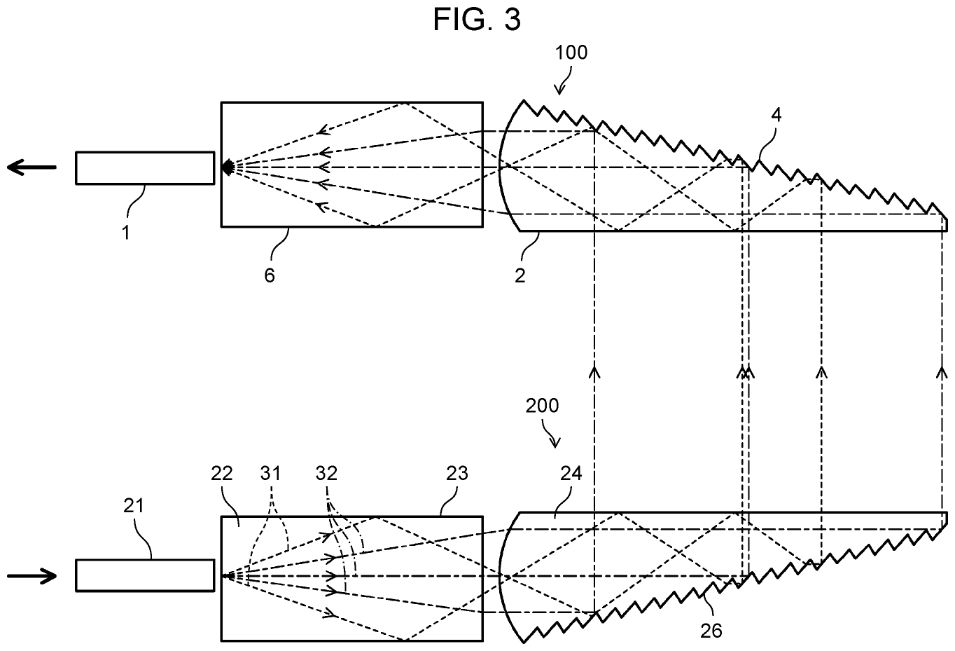

FIG. 3 is a sectional view schematically illustrating a configuration of light projector 200 according to another embodiment of the present disclosure. Light projector 200 in the present embodiment is disposed in pair with light receiver 100, thereby constituting the photoelectric sensor.

As illustrated in FIG. 3, light projector 200 according to the present embodiment includes second optical element 22 that collects light emitted from light projecting fiber 21, and first optical element 24 that receives the light emitted from second optical element 22 and projects the light toward light receiver 100.

In the present embodiment, light projector 200 has has a structure identical to a structure of the light receiver 100. In light projector 200, an optical path of the light emitted from projecting fiber 21 and emitted from first optical element 24 toward light receiver 100 is just opposite to the optical path, in light receiver 100, of the light incident on first optical element 2 and emitted to light receiving fiber 1.

That is, among the light emitted from light projecting fiber 21, light 32 that is incident on first optical element 24 without being reflected by side wall 23 of second optical element 22 is reflected by prism surface 26 of first optical element 24 and is projected to light receiver 100. On the other hand, light 31 reflected by side wall 23 of second optical element 22 and incident on first optical element 24 is totally reflected by side wall 23 of second optical element 22, is incident on first optical element 24, and is further reflected by prism surface 26 to be projected to light receiver 100. Therefore, the light incident efficiency on light receiver 100 can be improved.

Further, in the present embodiment, light receiver 100 and light projector 200 are disposed in pair to constitute the photoelectric sensor. Therefore, detection efficiency of an object in the photoelectric sensor can be improved.

According to the present disclosure, it is possible to provide a light receiver in which the light receiving efficiency of the light receiving fiber is improved, and a light projector in which the light incident efficiency on the light receiver is improved.

Although the present disclosure is described above with reference to the preferred embodiments, such description is not a limitation and, of course, various modifications can be made.

What is claimed is:

1. A light receiver for receiving light projected from a light projector and collecting the received light on a light receiving fiber, the light receiver comprising:
a first optical element emitting the light projected from the light projector toward the light receiving fiber; and
a second optical element collecting the light emitted from the first optical element on the light receiving fiber,
wherein the first optical element includes
a light incident surface on which the light projected from the light projector is incident, and
a prism surface on which a plurality of prism portions each having a triangular cross section are periodically formed in a direction inclined with respect to the light incident surface,
wherein each of the prism portions includes a first surface that reflects the light incident from the light incident surface toward the second optical element to be parallel to the light incident surface, and a second surface that reflects the light incident from the light incident surface in a direction opposite to the second optical element,
wherein the first surface of each of the prism portions includes a first region and a second region, the first region causing the light to be directly incident on the second optical element, the second region causing the light to transmit through the second surface of the prism portion, to be incident and to refract on the first surface of another prism portion adjacent to the prism portion, and to be incident on the second optical element while being totally reflected inside the first optical element, and
wherein the second optical element collects, on the light receiving fiber, the light incident from the first region and the light obtained by totally reflecting light incident from the second region by a side wall of the second optical element.

2. The light receiver of claim 1,
wherein an angle θ1 formed by the first surface and the light incident surface is an angle at which the light incident from the light incident surface is totally reflected by the first surface, and an angle θ2 formed by the second surface and the light incident surface is an angle at which the light reflected by the first surface is not totally reflected by the second surface.

3. The light receiver of claim 1,
wherein an angle θ1 formed by the first surface and the light incident surface and an angle θ2 formed by the second surface and the light incident surface satisfy a relationship of θ2>θ1.

4. The light receiver of claim 1,
wherein an intensity α of the light reflected by the first region, an intensity ß of the light reflected by the second region, and an intensity γ of the light reflected by the second surface satisfy a relationship of α≥ß≥γ.

5. The light receiver of claim 1,
wherein in a spread of the light emitted from the second optical element and incident on an end surface of the light receiving fiber, a spread W1 of the light incident from first region and a spread W2 of the light incident from the second region satisfy a relationship of W2≥W1.

6. A light projector for projecting light to the light receiver of claim 1,
wherein the light projector is disposed in pair with the light receiver and has a structure identical to a structure of the light receiver.

7. A photoelectric sensor comprising:
the light receiver of claim 1 and a light projector for projecting light to the light receiver,
wherein the light projector is disposed in pair with the light receiver and has a structure identical to a structure of the light receiver.
